(19) United States
(12) Patent Application Publication
(10) Pub. No.: US 2017/0279155 A1
(43) Pub. Date: Sep. 28, 2017

(54) ELECTROCHEMICAL DEVICE STACKS INCLUDING INTERLAYERS FOR REDUCING INTERFACIAL RESISTANCE AND OVER-POTENTIAL

(71) Applicant: APPLIED MATERIALS, INC., Santa Clara, CA (US)

(72) Inventors: Lizhong SUN, San Jose, CA (US); Byung Sung Leo KWAK, Portland, OR (US)

(21) Appl. No.: 15/505,859

(22) PCT Filed: Aug. 28, 2015
(86) PCT No.: PCT/US2015/047418

§ 371 Date: Feb. 22, 2017

Related U.S. Application Data
(60) Provisional application No. 62/043,261, filed on Aug. 28, 2014.

(51) Int. Cl. H01M 10/0585; H01M 10/0562; H01M 4/1395; H01M 4/04; H01M 4/134; H01M 4/1391; H01M 10/052; H01M 4/131

(52) U.S. Cl. CPC H01M 10/0585; H01M 10/052; H01M 10/0562; H01M 4/131; H01M 4/0419; H01M 4/134; H01M 4/1391; H01M 4/0421; H01M 4/0409; H01M 4/1395; H01M 4/0414

(57) ABSTRACT

Interlayers are included between electrode(s) and solid state electrolyte in electrochemical devices such as thin film batteries (TFBs), electrochromic (EC) devices, etc., Second Electrode in order to reduce the interfacial resistance and over-potential for promoting ion transport, such as lithium ion transport, through certain of the interfaces in the electrochemical device stack. Methods of manufacturing these electrochemical devices, and equipment for the same, are disclosed herein.

### CROSS-REFERENCE TO RELATED APPLICATIONS

This application claims the benefit of U.S. Provisional Application No. 62/043,261, filed Aug. 28, 2014,

### FIELD

Embodiments of the present disclosure relate generally to electrochemical devices and more specifically, although not exclusively, to electrochemical device stacks including an interlayer for reducing the resistance and over-potential at the interfaces with an electrode and a solid state electrolyte.

### BACKGROUND

Electrochemical devices such as thin film batteries (TFBs) and electrochromic devices (EC) include a thin film stack of layers including current collectors, a cathode (positive electrode), a solid state electrolyte and an anode (negative electrode).

The performance of these electrochemical devices is dependent on the ease of lithium transport through the layers of the stack, which is influenced not only by the impedance of each layer but also by the resistance/impedance at the interfaces between layers. As such, large charge transfer resistance at theses electrode/electrolyte interfaces in solid state thin film batteries has (or can have) a big impact on the overall lithium transport and therefore the battery performance, where some of the performance factors would be power capability and capacity utilization.

Clearly, there is a need for device structures and methods of manufacture that effectively reduce the interfacial resistance in these electrochemical devices in order to promote lithium transport through the interfaces.

### SUMMARY

The present disclosure relates, in general, to the introduction of interlayers between an electrode and the solid state electrolyte in electrochemical devices such as thin film batteries (TFBs), electrochromic (EC) devices, etc., in order to reduce the interfacial resistance and over-potential for promoting ion transport, such as lithium ion transport, through certain of the interfaces in the device stack.

According to some embodiments, a thin film electrochemical device may comprise: a first electrode layer comprising a first electrode material; an electrolyte layer, the electrolyte layer comprising an electrolyte material; a second electrode layer, the second electrode layer comprising a second electrode material; and at least one interlayer between and in contact with at least one of (a) the first electrode layer and the electrolyte layer and (b) the second electrode layer and the electrolyte layer; wherein the interlayer comprises an interlayer material characterized by (1) the interlayer material does not affect charge carrier intercalation/de-intercalation at interfaces between the electrolyte layer and either or both of the first and second electrode layers, (2) the interlayer material reduces resistance and over-potential at interfaces between the electrolyte layer and either or both of the electrode layers; (3) the electromotive force (emf) of the interlayer material compared with lithium metal is lower than the emf of the first or second electrode material versus lithium metal; and (4) as deposited, the interlayer material is an ion conductor, such as a lithium ion conductor.

According to some embodiments, a method of making a thin film electrochemical device may comprise: depositing a device stack comprising a first electrode layer, an electrolyte layer, a second electrode layer and at least one interlayer, the at least one interlayer being deposited on at least one of (a) the first electrode layer, wherein the electrolyte layer is deposited on the at least one interlayer, and (b) the electrolyte layer, wherein the second electrode layer is deposited on said at least one interlayer; wherein the at least one interlayer comprises an interlayer material characterized by (1) the interlayer material does not affect charge carrier intercalation/de-intercalation at interfaces between the electrolyte layer and either or both of the first and second electrode layers, (2) the interlayer material reduces resistance and over-potential at interfaces between the electrolyte layer and either or both of the electrode layers; (3) the electromotive force (emf) of the interlayer material compared with lithium metal is lower than the emf of the first or second electrode material versus lithium metal; and (4) as deposited, the interlayer material is an ion conductor, such as a lithium ion conductor.

According to further embodiments an apparatus for manufacturing electrochemical devices may comprise: a system for depositing a device stack comprising a first electrode layer, an electrolyte layer, a second electrode layer and at least one interlayer, the at least one interlayer being deposited on at least one of (a) the first electrode layer, wherein one of the at least one interlayer is between and in contact with the first electrode layer and the electrolyte layer, and (b) the electrolyte layer, wherein one of the at least one interlayer is between and in contact with the electrolyte layer and the second electrode layer; wherein the at least one interlayer comprises an interlayer material characterized by (1) the interlayer material does not affect charge carrier intercalation/de-intercalation at interfaces between the electrolyte layer and either or both of the first and second electrode layers, (2) the interlayer material reduces resistance and over-potential at interfaces between the electrolyte layer and either or both of the electrode layers; (3) the electromotive force (emf) of the interlayer material compared with lithium metal is lower than the emf of the first or second electrode material versus lithium metal; and (4) as deposited, the interlayer material is an ion conductor, such as a lithium ion conductor.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a schematic cross-sectional representation of a thin film battery with interlayers for reducing the resistance and over-potential at the interfaces between the electrodes and the solid state electrolyte, according to some embodiments;

FIG. 2 is a schematic representation of an electrochromic device with interlayers for reducing the resistance and over-potential at the interfaces between the electrodes and the solid state electrolyte, according to some embodiments;

FIG. 3 is a schematic cross-sectional representation of an electrochemical device with interlayers for reducing the resistance and over-potential at the interfaces between the electrodes and the solid state electrolyte, according to some embodiments;

FIG. 4 is a flow chart for deposition of an electrochemical device with one or more interlayers, according to some embodiments;

FIG. 5 shows c-rate dependence of utilization for TFB batteries with and without a TiO₂ interlayer, according to some embodiments;

FIG. 6 shows charging-discharging curves of a TFB device with a TiO₂ interlayer between a LiCoO₂ cathode and a LiPON electrolyte, according to some embodiments;

FIG. 7 is a schematic illustration of a thin film deposition cluster tool, according to some embodiments;

FIG. 8 is a representation of a thin film deposition system with multiple in-line tools, according to some embodiments; and

FIG. 9 is a representation of an in-line deposition tool and substrate conveyor, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The present disclosure describes electrochemical device structures and methods of fabricating the electrochemical devices including one or more thin interlayers between an electrode (positive and/or negative) and the solid state electrolyte (LiPON, for example), for reducing the resistance and over-potential at the interfaces with the electrode and the solid state electrolyte. Furthermore, the device may include an interlayer comprising a multiplicity of layers of different materials between an electrode and the electrolyte in order to create a “cascading” chemical potential through the interlayer.

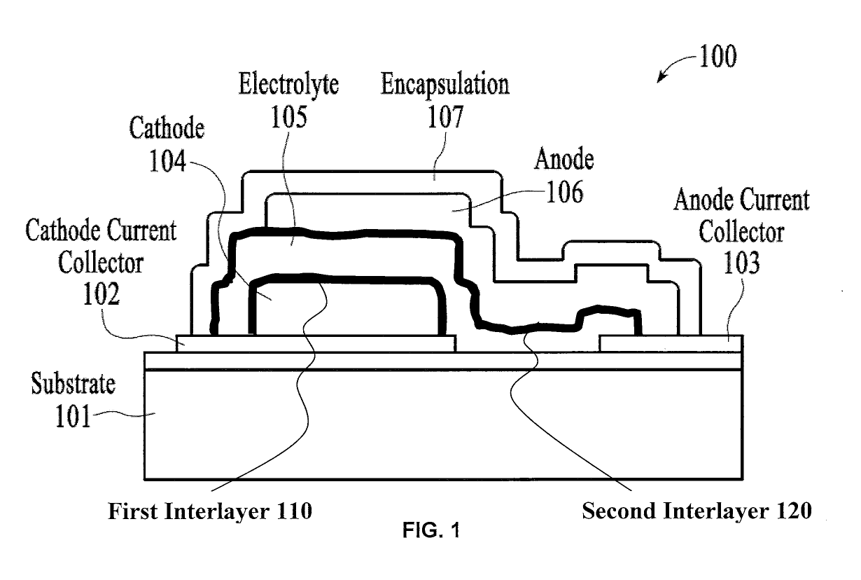

FIGS. 1-3 show schematic cross-sectional representations of thin film electrochemical devices with interlayers for reducing the resistance and over-potential at the interfaces between the electrodes and the solid state electrolyte, according to some embodiments.

FIG. 1 shows a first TFB (thin film battery) device structure 100 with cathode current collector 102 and anode current collector 103 formed on a substrate 101, followed by cathode 104, first interlayer 110, electrolyte 105, second interlayer 120, and anode 106; although the device may be fabricated with the cathode, electrolyte and anode in reverse order. Furthermore, the cathode current collector (CCC) and anode current collector (ACC) may be deposited separately. For example, the CCC may be deposited before the cathode and the ACC may be deposited after the electrolyte and second interlayer. The device may be covered by an encapsulation layer 107, such as parylene, to protect the environmentally sensitive layers from oxidizing agents. Note that the component layers are not drawn to scale in the TFB device shown in FIG. 1.

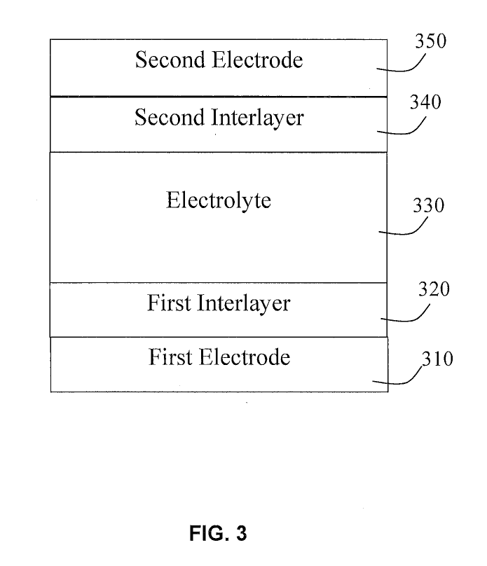

According to embodiments the TFB device of FIG. 1 may be fabricated by the following process: provide substrate; deposit patterned CCC; deposit patterned ACC; deposit patterned cathode; cathode anneal; deposit first patterned interlayer; deposit patterned electrolyte; deposit second patterned interlayer; deposit patterned anode; and deposit patterned encapsulation layer. Shadow masks may be used for the deposition of patterned layers. In embodiments the cathode is LiCoO₂ and the anneal is at a temperature of up to 850° C. Furthermore, some embodiments of TFBs according to the present disclosure may be fabricated using blanket layer deposition (maskless deposition) for one or more of the device layers; for example, a TFB stack, with a stack similar to that of the electrochemical device stack of FIG. 3, may be fabricated using maskless layer deposition.

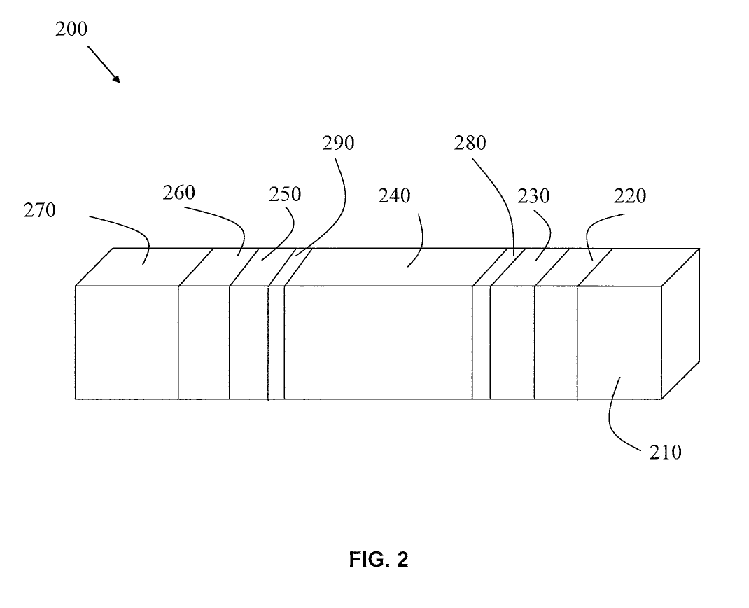

An electrochromic (EC) device 200 is represented in FIG. 2. The device 200 comprises a transparent substrate 210, lower transparent conductive oxide (TCO) layer 220, a cathode 230, a first interlayer 280, a solid electrolyte 240, a second interlayer 290, a counter electrode (anode) 250, and upper TCO layer 260. For encapsulation 270 there may be an additional substrate/glass or transparent thin film permeation barrier layers on the opposite side to the transparent substrate 210. Note that the component layers are not drawn to scale in the electrochromic device shown in FIG. 2.

According to embodiments the electrochromic device of FIG. 2 may be fabricated by the following process: provide substrate; deposit lower transparent conductive oxide (TCO) layer (in embodiments the TCO layer may be annealed to improve the optical transparency and electrical conductivity); deposit cathode, for example WO₃; cathode anneal; deposit first interlayer; deposit solid electrolyte; deposit second interlayer; deposit counter electrode (anode); deposit lithium layer; deposit upper TCO layer; and deposit or affix encapsulation layers or substrate, respectively.

FIG. 3 shows an example of an electrochemical device with a vertical stack fabricated according to embodiments of the present disclosure with one or more interlayers. In FIG. 3, the vertical stack comprises: a first electrode layer 310, an interlayer 320, an electrolyte layer 330, a second interlayer 340 and a second electrode layer 350. The first and second electrode layers will typically be anode and cathode. There may also be (not shown) a substrate, current collectors for the first electrode layer and/or second electrode layer, a protective coating over the entire stack, and electrical contacts for the electrodes. Furthermore, the device may include an interlayer comprising a multiplicity of layers of different materials between an electrode and the electrolyte in order to create a “cascading” chemical potential through the interlayer.

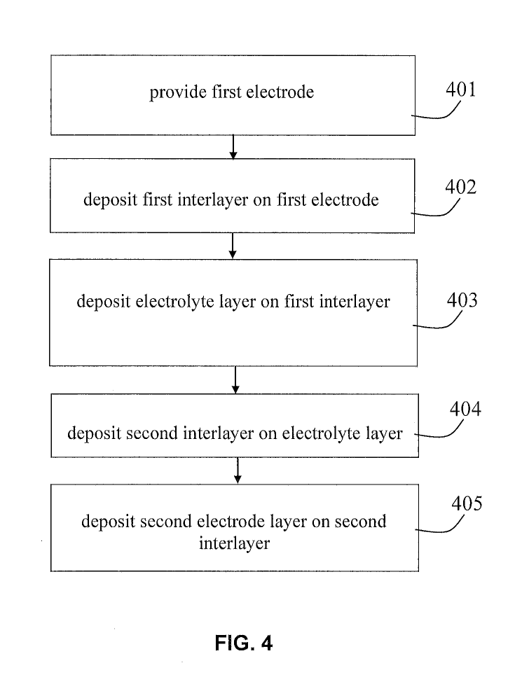

FIG. 4 provides a process flow, according to some embodiments for inclusion of an interlayer or interlayers between the electrolyte and one or more of the electrodes of an electrochemical device such as a TFB or EC device. The process flow for fabrication of an electrochemical device with one or more interlayers may include: providing a first electrode (401); depositing a first interlayer on the first electrode (402); depositing an electrolyte layer on the first interlayer (403); depositing a second interlayer on the electrolyte layer (404); and depositing a second electrode layer on the second interlayer (405). Herein the first and second electrodes may be an anode and a cathode. The process may further include depositing multiple layers of different materials on top of each other between an electrode layer and the electrolyte layer in order to create a “cascading” chemical potential through the interlayer. Example device stacks include: anode-interlayer-electrolyte-cathode; anode-electrolyte-interlayer-cathode; anode-interlayer-electrolyte-interlayer-cathode; anode-interlayer-interlayer-electrolyte-cathode; anode-electrolyte-interlayer-interlayer-cathode, etc.

Furthermore, the process flow may be described as a method of making a thin film electrochemical device comprising: depositing a device stack comprising, in order, a first electrode layer, an electrolyte layer, and a second electrode layer; and depositing at least one interlayer, the interlayer being deposited in the stack either on the first electrode layer or on the electrolyte layer. As above, the process may further include depositing multiple layers of different materials on top of each other between an electrode layer and the electrolyte layer in order to create a “cascading” chemical potential through the interlayer.

An example of a cathode layer is a LiCoO₂ layer, of a anode layer is a Li metal layer, of an electrolyte layer is a LiPON layer. However, it is expected that a wide range of cathode materials such as NMC (NiMnCo oxide), NCA (NiCoAl oxide), LMO (LiₓMnO₂), LFP (LiₓFePO₄), LiMn spinel, etc. may be used, a wide range of anode materials such as Si, Al, Sn, etc. may be used, and a wide range of lithium-conducting electrolyte materials such as LLZO (LiLaZr oxide), LiSiCON, etc. may be used. Deposition techniques for these layers may be any deposition technique that is capable of providing the desired composition, phase and crystallinity, and may include deposition techniques such as PVD (physical vapor deposition), reactive sputtering, non-reactive sputtering, RF (radio frequency) sputtering, multi-frequency sputtering, evaporation, CVD (chemical vapor deposition), ALD (atomic layer deposition), etc. The deposition method can also be non-vacuum based, such as plasma spray, spray pyrolysis, slot die coating, screen printing, etc. The materials of the interlayer can be selected from metal oxides such as TiO₂, Ta₂O₅, ZrO₂, ZnO, SnO₂, Al₂O₃ and including cathodically active battery materials (e.g. materials with a lower chemical potential than the cathode) such as TiOₓ, TiS₂, etc., where the interlayer materials satisfy the following criteria:

1) the interlayer material does not affect Li intercalation/de-intercalation at either interface;

2) the interlayer material reduces resistance and overpotential at interfaces between the interlayer and both the electrode layer and the electrolyte layer;

3) for an interlayer between a lithium-containing cathode layer and an electrolyte layer, the electromotive force of the interlayer material compared with lithium metal is lower than the emf of the host cathode material versus lithium metal;

4) for an interlayer between an anode layer and an electrolyte layer, the electromotive force of the interlayer material compared with lithium metal is lower than the emf of the host anode material versus lithium metal; and

5) the interlayer material as deposited is an ion conductor, such as a lithium ion conductor, and is generally an electron conductor, although in embodiments the interlayer may be electrically non-conductive when thin enough for electron tunneling.

Furthermore, it is expected that performance of a particular interlayer composition will be strongly dependent on good control over the composition, phase and crystallinity of the interlayer.

The thickness of the interlayer in embodiments may be in the range of 3 nm-200 nm, and in some embodiments the thickness may be in the range of 10 nm-50 nm. While the demonstration of the concept was with a PVD (physical vapor deposition) sputtered interlayer, it is expected that the concept is agnostic to the method of deposition—for example the deposition technique for the interlayer may be any deposition technique that is capable of providing the desired composition, phase and crystallinity, and may include deposition techniques such as PVD, reactive sputtering, non-reactive sputtering, RF (radio frequency) sputtering, multi-frequency sputtering, evaporation, CVD (chemical vapor deposition), ALD (atomic layer deposition), etc.. The deposition method can also be non-vacuum based, such as plasma spray, spray pyrolysis, slot die coating, screen printing, etc. Also, the demonstration was with a single interlayer, but one can conceive of multiple interlayers creating a “cascading” chemical potential through the interlayers between the electrode layer and the electrolyte layer—for example, between the electrode layer and the electrolyte there may be a layer of Ta₂O₅, then a layer of TiS₂ and then a layer of TiOₓ.

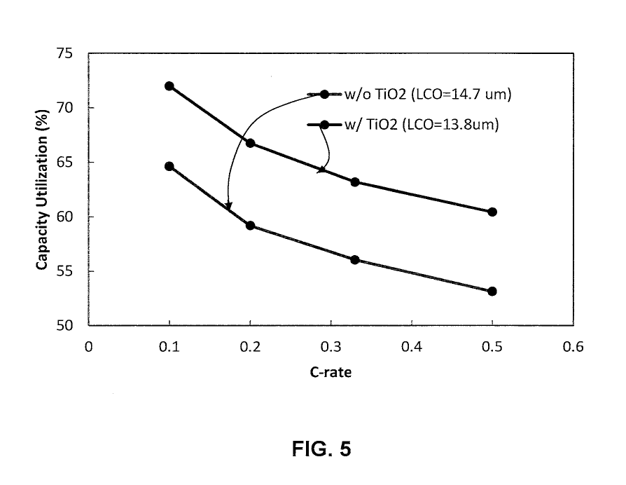

With the addition of a TiOₓ interlayer, the interfacial resistance between a LiCoO₂ cathode layer and a LiPON electrolyte layer, appears to be reduced, as shown in the Table below. Furthermore, FIG. 5 displays a difference in C-rate (cell capacity rate) dependence of capacity utilization for the samples with and without the interlayer. It is suspected that these apparent differences are due to the better matching of the electrochemical potential between the LiCoO₂ and LiPON layers, due to the interfacial layer alone. Furthermore, it may be that the fabrication of the device stack with the interlayer may lead to the formation of a transition layer (mixture of Li, Co, and a transition metal oxide of the interlayer for example) which has a lower resistance than the interface without the interlayer, resulting in a lower over-potential requirement at the interface and an overall battery performance improvement. (If the transition layer is needed, then it is expected that annealing may be effective in forming such a transition layer; annealing may also improve the crystallinity of the interlayer.) The material used in Table 1 and FIG. 5 is TiOₓ, where 1.3≦x≦2.0, which is also a cathode material but of lower chemical potential than LiCoO₂. As such, this lower chemical potential layer may make it easier energetically for Li intercalation—reducing the overall impedance and leading to better battery performance. An analogous situation is expected for the negative electrode and electrolyte interface. Having such an oxide/cathode layer at the Li-electrolyte interface may make Li ion transport easier as TiOₓ—Li would induce Li ions to intercalate “naturally” into TiOₓ first (solid electrolytes such as LiPON are stable chemically and electrochemically against Li), creating an interlayer comprising Li ions even before applying the driving voltage to use/discharge the battery.

TABLE 1
An example of IR Drop Comparison of TFB Batteries with and without a
TiOₓ Interlayer between the LCO electrode and the LiPON electrolyte.

| | LCO | | | | | Discharge | IR @ | |
|---|---|---|---|---|---|---|---|---|
| | Thickness | TiO₂ | Charging | Discharging | IR | Current | 100 μA/cm² | IR |
| ID | (μm) | layer | Voltage | Voltage | (V) | (μA) | (V) | (Ω/cm² · μm) |
| without TiOₓ | 14.7 | No | 4.2 | 4.168 | 0.0320 | 103.5 | 0.031 | 21 |
| with TiOₓ | 13.8 | Yes | 4.2 | 4.179 | 0.0210 | 93.1 | 0.023 | 16 |
| (~3 nm thick) | | | | | | | | |

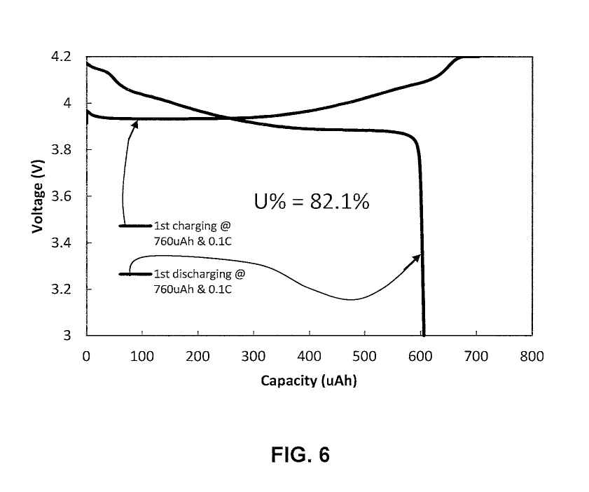

FIG. 6 shows charging and discharging curves of a solid state thin film battery comprising a Li anode and a thin TiOₓ interlayer between the LiCoO₂ and LiPON layers. The TFB capacity utilization reached 82% at 11 microns of LiCoO₂—this is a significant result and is an improvement in performance over the same device without the interlayer, demonstrating the utility of the methods and structures of the present disclosure.

It is expected that embodiments of the present disclosure will be well suited for use with solid state batteries with higher voltage cathodes/positive electrolyte layers, such as LiCoO₂ and LiPON, providing improved performance as measured by capacity utilization, rate capability and/or cycle life, for example.

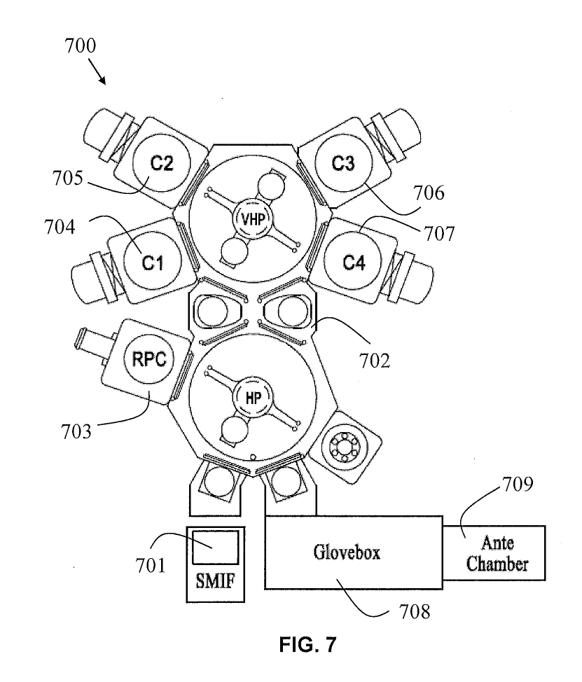

FIG. 7 is a schematic illustration of a processing system 700 for fabricating an electrochemical device, such as a TFB or EC device, according to some embodiments. The processing system 700 includes a standard mechanical interface (SMIF) 701 to a cluster tool 702 equipped with a reactive plasma clean (RPC) chamber 703 and process chambers C1-C4 (704, 705, 706 and 707), which may be utilized in the process steps described above. A glovebox 708 may also be attached to the cluster tool. The glovebox can store substrates in an inert environment (for example, under a noble gas such as He, Ne or Ar), which is useful after alkali metal/alkaline earth metal deposition. An ante chamber 709 to the glovebox may also be used if needed—the ante chamber is a gas exchange chamber (inert gas to air and vice versa) which allows substrates to be transferred in and out of the glovebox without contaminating the inert environment in the glovebox. (Note that a glovebox can be replaced with a dry room ambient of sufficiently low dew point as such is used by lithium foil manufacturers.) The chambers C1-C4 can be configured for process steps for manufacturing electrochemical devices which may include, for example: deposition of an interlayer over an electrode layer—for example deposition of TiOₓ by PVD over a layer of LiCoO₂ deposited by reactive sputtering, followed by deposition of an electrolyte layer (for example LiPON deposited by a method such as RF sputtering or multi-frequency sputtering of a Li₃PO₄ target in a N₂ ambient) over the interlayer, followed by deposition of a second electrode layer such as Li, Si, Al, Sn, etc., as described above. Examples of suitable cluster tool platforms include display cluster tools. It is to be understood that while a cluster arrangement has been shown for the processing system 700, a linear system may be utilized in which the processing chambers are arranged in a line without a transfer chamber so that the substrate continuously moves from one chamber to the next chamber.

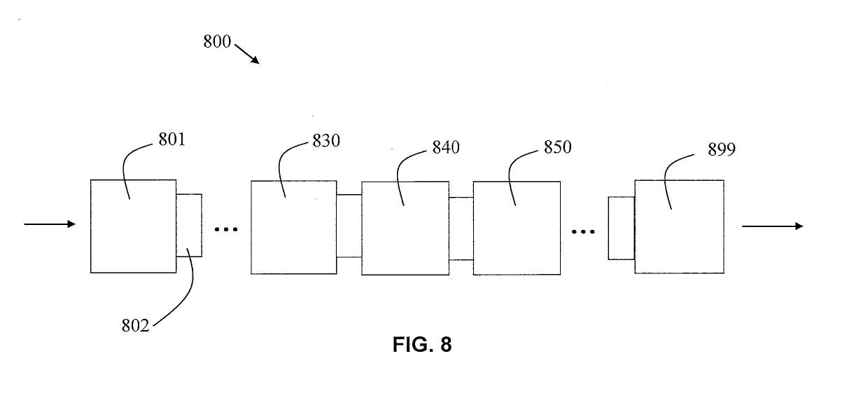

FIG. 8 shows a representation of an in-line fabrication system 800 with multiple in-line tools 801 through 899, including tools 830, 840, 850, according to some embodiments. In-line tools may include tools for depositing all the layers of an electrochemical device—including both TFBs and electrochromic devices. Furthermore, the in-line tools may include pre- and post-conditioning chambers. For example, tool 801 may be a pump down chamber for establishing a vacuum prior to the substrate moving through a vacuum airlock 802 into a deposition tool. Some or all of the in-line tools may be vacuum tools separated by vacuum airlocks. Note that the order of process tools and specific process tools in the process line will be determined by the particular electrochemical device fabrication method being used. For example, as specified in the process flows described above. Furthermore, substrates may be moved through the in-line fabrication system oriented either horizontally or vertically.

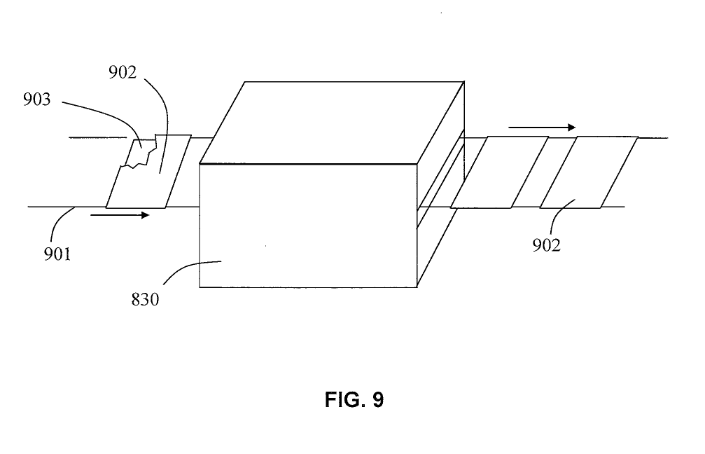

In order to illustrate the movement of a substrate through an in-line fabrication system such as shown in FIG. 8, in FIG. 9 a substrate conveyer 901 is shown with only one in-line tool 830 in place. A substrate holder 902 containing a substrate 903 (the substrate holder is shown partially cut-away so that the substrate can be seen) is mounted on the conveyer 901, or equivalent device, for moving the holder and substrate through the in-line tool 830, as indicated. An in-line platform for processing tool 830 may in some embodiments be configured for vertical substrates, and in some embodiments configured for horizontal substrates.

An apparatus for manufacturing electrochemical devices may comprise: a system for depositing a device stack comprising a first electrode layer, an electrolyte layer, a second electrode layer and at least one interlayer, the at least one interlayer being deposited on at least one of (a) the first electrode layer, wherein one of the at least one interlayer is between and in contact with the first electrode layer and the electrolyte layer, and (b) the electrolyte layer, wherein one of the at least one interlayer is between and in contact with the electrolyte layer and the second electrode layer; wherein the at least one interlayer comprises an interlayer material characterized by (1) the interlayer material does not affect charge carrier intercalation/de-intercalation at interfaces between the electrolyte layer and either or both of the first and second electrode layers, (2) the interlayer material reduces resistance and over-potential at interfaces between the electrolyte layer and either or both of the electrode layers; (3) the electromotive force (emf) of the interlayer material compared with lithium metal is lower than the emf of the first or second electrode material versus lithium metal; and (4) as deposited, the interlayer material is an ion conductor, such as a lithium ion conductor. Furthermore, in embodiments the system may further deposit current collector layers and protective coatings. The system may be a cluster tool, an in-line tool, stand-alone tools, or a combination of one or more of the aforesaid tools.

Although embodiments of the present disclosure have been particularly described with reference to lithium ion electrochemical devices, the teaching and principles of the present disclosure may also be applied to electrochemical devices based on transport of other ions, such as protons, sodium ions, etc.

Although embodiments of the present disclosure have been particularly described with reference to TFB devices, the teaching and principles of the present disclosure may also be applied to various electrochemical devices including electrochromic devices, electrochemical sensors, electrochemical capacitors, etc.

Although embodiments of the present disclosure have been particularly described with reference to certain embodiments thereof, it should be readily apparent to those of ordinary skill in the art that changes and modifications in the form and details may be made without departing from the spirit and scope of the disclosure.

What is claimed is:

1. A thin film electrochemical device comprising:
a first electrode layer comprising a first electrode material;
an electrolyte layer, said electrolyte layer comprising an electrolyte material;
a second electrode layer, said second electrode layer comprising a second electrode material; and
at least one interlayer between and in contact with at least one of (a) the first electrode layer and the electrolyte layer and (b) the second electrode layer and the electrolyte layer;
wherein said interlayer comprises an interlayer material characterized by (1) said interlayer material does not affect charge carrier intercalation/de-intercalation at interfaces between said electrolyte layer and either or both of said first and second electrode layers, (2) said interlayer material reduces resistance and over-potential at interfaces between said electrolyte layer and either or both of said electrode layers; (3) the electromotive force (emf) of said interlayer material compared with lithium metal is lower than the emf of said first or second electrode material versus lithium metal; and (4) as deposited, said interlayer material is an ion conductor.

2. The thin film electrochemical device of claim 1, wherein said interlayer material is an electron conductor.

3. The thin film electrochemical device of claim 1, wherein said thin film electrochemical device is a thin film battery.

4. The thin film electrochemical device of claim 1, wherein said interlayer material is at least one of TiO₂, Ta₂O₅, ZrO₂, ZnO, SnO₂, Al₂O₃, TiS₂ and TiOₓ where 1.3≦x≦2.0.

5. The thin film electrochemical device of claim 1, wherein said first electrode material is LiCoO₂, said electrolyte material is LiPON and said at least one interlayer between said first electrode and said electrolyte comprises TiOₓ, where 1.3≦x≦2.0.

6. The thin film electrochemical device of claim 1, wherein said second electrode material is Li, said electrolyte material is LiPON and said interlayer between said first electrode and said electrolyte comprises TiOₓ, where 1.3≦x≦2.0.

7. The thin film electrochemical device of claim 1, wherein said first electrode material is LiCoO₂, said electrolyte material is LiPON and said at least one interlayer between said first electrode and said electrolyte comprises a layer of Ta₂O₅ on said first electrode material, a layer of TiS₂ on said layer of Ta₂O₅, and a layer of TiOₓ, where 1.3≦x≦2.0, on said layer of TiS₂, said electrolyte being on said layer of TiOₓ.

8. The thin film electrochemical device of claim 1, wherein said at least one interlayer has a thickness in the range of 3 nm to 200 nm.

9. The thin film electrochemical device of claim 1, wherein said interlayer material is a lithium ion conductor.

10. A method of making a thin film electrochemical device comprising:
depositing a device stack comprising a first electrode layer, an electrolyte layer, a second electrode layer and at least one interlayer, said at least one interlayer being deposited on at least one of (a) said first electrode layer, wherein said electrolyte layer is deposited on said at least one interlayer, and (b) said electrolyte layer, wherein said second electrode layer is deposited on said at least one interlayer;
wherein said at least one interlayer comprises an interlayer material characterized by (1) said interlayer material does not affect charge carrier intercalation/de-intercalation at interfaces between said electrolyte layer and either or both of said first and second electrode layers, (2) said interlayer material reduces resistance and over-potential at interfaces between said electrolyte layer and either or both of said electrode layers; (3) the electromotive force (emf) of said interlayer material compared with lithium metal is lower than the emf of said first or second electrode material versus lithium metal; and (4) as deposited, said interlayer material is an ion conductor.

11. The method of claim 10, wherein said interlayer material is an electron conductor.

12. The method of claim 10, wherein said thin film electrochemical device is a thin film battery.

13. The method of claim 10, wherein said interlayer material is at least one of TiO₂, Ta₂O₅, ZrO₂, ZnO, SnO₂, Al₂O₃, TiS₂ and TiOₓ where 1.3≦x≦2.0.

14. The method of claim 10, wherein said at least one interlayer has a thickness in the range of 3 nm to 200 nm.

15. An apparatus for manufacturing electrochemical devices comprising:
a system for depositing a device stack comprising a first electrode layer, an electrolyte layer, a second electrode layer and at least one interlayer, said at least one interlayer being deposited on at least one of (a) said first electrode layer, wherein one of said at least one interlayer is between and in contact with said first electrode layer and said electrolyte layer, and (b) said electrolyte layer, wherein one of said at least one interlayer is between and in contact with said electrolyte layer and said second electrode layer;
wherein said at least one interlayer comprises an interlayer material characterized by (1) said interlayer material does not affect charge carrier intercalation/de-intercalation at interfaces between said electrolyte layer and either or both of said first and second electrode layers, (2) said interlayer material reduces resistance and over-potential at interfaces between said electrolyte layer and either or both of said electrode layers; (3) the electromotive force (emf) of said interlayer material compared with lithium metal is lower than the emf of said first or second electrode material versus lithium metal; and (4) as deposited, said interlayer material is an ion conductor.
